(19) United States
(12) Patent Application Publication
(10) Pub. No.: US 2006/0120686 A1
(43) Pub. Date: Jun. 8, 2006

(54) Method, apparatus and system for storage and retrieval of images

(76) Inventor: Frank Liebenow, Treasure Island, FL (US)

Correspondence Address: LARSON AND LARSON, 11199 69TH STREET NORTH, LARGO, FL, 33773, US

(21) Appl. No.: 11/005,512

(22) Filed: Dec. 3, 2004

(51) Int. Cl. H04N 11/04

(52) U.S. Cl. 386/40

(57) ABSTRACT

A method and apparatus for identifying objects within a digital image and storing the object identification so that the object identification can be searched at a later time to find all images that match a particular object identification. The object identification is stored in the digital image or in an auxiliary database.

### FIELD OF THE INVENTION

The present invention generally relates to the field of storing and retrieving image files, and in particular where the image files is analyzed and categorized to facilitate locating and retrieving stored images.

### BACKGROUND OF THE INVENTION

With the advent of digital photography, many people are switching from film, prints and negatives to digital representation of images, perhaps JPEG images. Digital photography allows the photographer to take large numbers of images at little incremental cost, then afterwards, the photographer can sort through the images, select those desired for printing and print only those needed. Memory cards for storage in digital cameras are increasing in capacity and decreasing in cost, making it easy to take many more pictures than are needed. Furthermore, large hard disk drives within computer systems are making storage of thousands on thousands of images easy and economical.

Unfortunately, capturing or “taking” hundreds or thousands of images leads to hundreds or thousands of files with no better descriptive information than, “PIC0001.JPG,” possibly a date the image was created and an image resolution. Many people have a disk full of numbered images. Furthermore, for those individuals who are conscientious about naming their images, the file naming facilities only allow simple file names, perhaps “dad_and_rover.jpg.” Furthermore, searching for a picture of dad and rover in a file system with many folders and many files, perhaps many with dad and rover, becomes a difficult and time-consuming task.

Imaging applications have tackled this problem in various ways, creating overlay file systems or databases that allow a user to enter searchable description information about every picture stored. This system may function well when retrieving images, but requires the user to enter the same keywords or names for each picture as it is entered into the system, creating a tedious task when importing a few hundred images from a camera.

A partial solution to this problem is presented in “Automatic Cataloging of People in Digital Photographs,” U.S. Pat. No. 6,606,398 to Fredrick J. Cooper which is hereby incorporated by reference. In this patent, faces may be recognized and names associated with them in a database. This invention may solve part of the problem presented, but falls short because having a large inventory of images may also mean having a large number of images that include a particular face. Searching for an image that includes a particular face may yield hundreds of images. Other criteria might help narrow that search but are not included in this patent. For example, daytime, nighttime or sunset, trees present, water present, etc. These additional qualifying parameters would help find the requested face in a proper context, perhaps finding Jane on the beach with palm trees, wearing a bathing suit and holding a margarita. The cited patent would not enable such a search.

Therefore, a method of automatically categorizing images as they enter the system is needed.

### SUMMARY OF THE INVENTION

The present invention is directed to a means categorizing and organizing digital images. The present invention includes image recognition to determine various subjects within a given image, then comparing them to a knowledge base of previous subjects, templates or images; then associating attributes or keywords with the image that may enhance searching, selecting and sorting images.

In one embodiment, the image recognition may include contextual categorization of various artifacts that may be easy to recognize. For example, daytime verses nighttime, indoor verses outdoor, animal pictures, people pictures, water bodies, etc. These attributes may be detected by finding relative simple shapes and colors like the moon, sun, flesh tone colors, grass colors, water colors, sky colors, sharp edges like room walls and the like. In an embodiment of the present invention, attributes may be set as the image is introduced to the system or may be analyzed and set by processing the images later, perhaps as a background task or a task that runs when the user isn't using the system for other purposes. Once recognition is complete, attributes or keywords may be stored within the image file, perhaps in an auxiliary data field, or may be stored in the file system and associated with the image file, perhaps in an image database.

In another embodiment, the image recognition may include object and contextual recognition. For example, a dog, a cat, a person, a tree, a palm tree, an oak tree, a window, a lawn, an ocean, a sunset, stars, the sun, the moon, etc., may be recognized. This embodiment may include a preset number of recognizable objects, and may query the user when it finds an object that it does not recognize. For example, if an image of Jupiter is introduced and Jupiter isn't already known to the system, the system will request the user to define the object, perhaps highlighting or circling Jupiter within the displayed image while allowing the user to type in a name for this object. In this embodiment, attributes may be set as the image is introduced to the system or may be analyzed and attributes set by processing the images later, perhaps as a background task or a task that runs when the user isn't using the system for other purposes. If done in the background, the user may be requested to identify objects once all unidentified objects are recognized. Once recognition is complete, attributes or keywords may be stored within the image file, perhaps in an auxiliary data field, or may be stored in the file system and associated with the image file, perhaps in an image database.

In another embodiment, the image recognition may also include detailed recognition. For example, Jane, John, Spot, Rover, etc., may be recognized with more detail than simply determining that the object is a person of a dog, etc. In this embodiment, recognition may be able to distinguish between different people, perhaps distinguishing between different animals such as spot and rover or even differences between different intimate objects such as tree species, one house verses another, etc. The present invention may also include a preset number of recognizable objects such as those in the previous embodiment plus some well known, recognizable objects such as the Eiffel Tower, Golden Gate Bridge, Empire State Building, etc., and may query the user when it finds an object or person that it does not recognize. For example, if an image of Jane is introduced and Jane isn't already known to the system, the system will request the user to define the object, perhaps the system would highlight or circle Jane within the displayed image while allowing the user to type in a name and perhaps other attributes for this person. Attributes may be set as the image is introduced into the system or may be analyzed and set by processing the images in bulk, perhaps as a background task or a task that runs when the user isn't using the system for other purposes. If done in the background, the user may be requested to identify objects once all unidentified objects are recognized. Once recognition is complete, attributes or keywords may be stored within the image file, perhaps in an auxiliary data field, or may be stored in the file system and associated with the image file, perhaps in an image database.

It is to be understood that both the forgoing general description and the following detailed description are exemplary only and are not restrictive of the invention as claimed. The general functions of this invention may be combined in different ways to provide the same functionality while still remaining within the scope of this invention. The recognition and identification function may be performed within an image capture device, such as a camera or scanner, or may be performed by a computer system, perhaps having greater resources than the camera or scanner. Once recognition is performed, image attributes or keywords may be stored as auxiliary data within the image file or may be stored in a database associated with the images.

### BRIEF DESCRIPTION OF THE DRAWINGS

The numerous advantages of the present invention may be better understood by those skilled in the art by reference to the accompanying figures in which:

FIG. 1 shows four typical images that may be processed by the present invention.

FIG. 2 shows an additional typical image that may be processed by the present invention and an image database created by the present invention.

FIG. 3 shows a typical object collection of the present invention.

FIG. 4 shows a flow chart of the present invention.

FIG. 5 shows an example of a user interface for entering attribute information related to an object that doesn't match an object already within the object information database of the present invention.

FIG. 6 shows a schematic of an exemplary system of the present invention.

### DETAILED DESCRIPTION

Reference will now be made in detail to the presently discussed embodiment of the invention, an example of which is illustrated in the accompanying drawings.

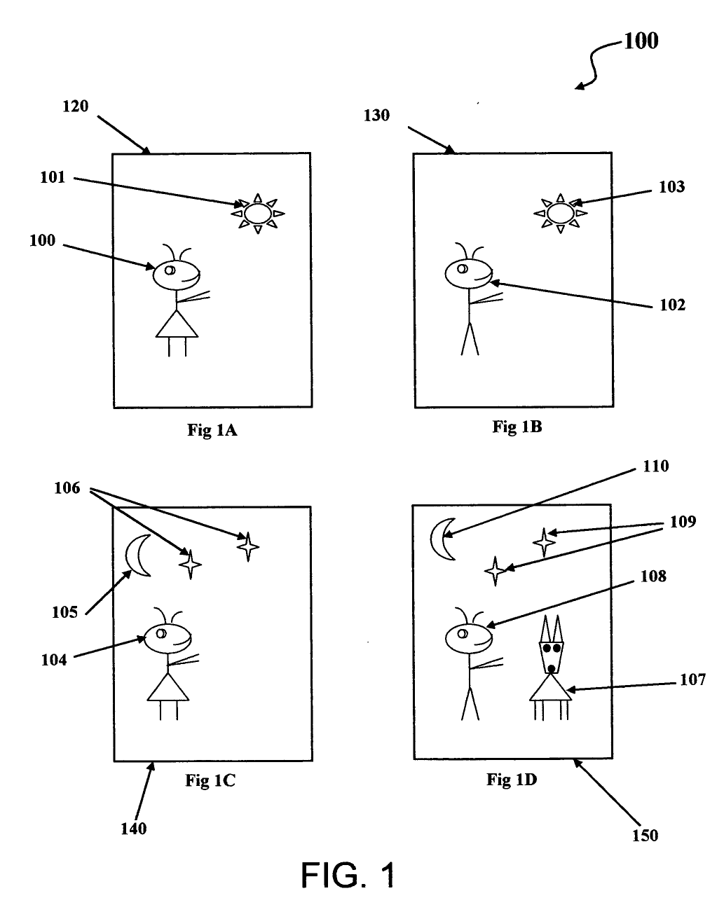

Referring now to FIG. 1, a series of images will be used to show an embodiment of the present invention. Throughout this description, image, picture, photo and perhaps other words are used to describe a digital image that is stored in digital form, perhaps on a drive, media card, disk, optical storage, etc. These terms are different words for the same thing and should be interchangeable. Also, a common image file format is JPEG and may be used throughout this description. JPEG is a lossy, compression format for the digital storage of images. Any other format known in the industry may be used, including TGA, TIFF, MPEG, etc. The described invention is not dependent on the image format.

Referring now to FIG. 1, four images are shown: FIG. 1A, FIG. 1B, FIG. 1C and FIG. 1D. FIG. 1A or image 120 includes two objects; a woman 100 and sun 101. FIG. 1B. or image 130 contains two objects; a man 102 and sun 103. FIG. 1C or image 140 contains four objects; a woman 104, a moon 105 and two stars 106. FIG. 1D or image 150 contains five objects; a dog 107, a man 108, two stars 109 and a moon 110. For simplicity only four images are shown, but these four images may be part of a much larger collection of images with similar and different objects. By looking at the images 120 and 130, it may be determined that these images were taken in the daytime, perhaps based on the presence of the sun 101 and 103. By looking at images 140 and 150, it may be determined that these images were taken at night, perhaps based on the presence of the moon 105 and 110 or based on the presence of stars 106 and 109, or the combination of the two. In an embodiment of the present invention, each image is analyzed, perhaps by software, to recognize certain objects within that object so that attributes may be automatically assigned to that image, perhaps by adding these attributes to a database that is searchable. The individual objects may be detected using various methods known in the art such as edge detection. Perhaps significant color differences or contrasts may be used to locate the start of each image. These attributes are now searchable criteria and can be used by a search program to locate images containing each particular object. In this example, an attribute of “daytime” may be added to database records for images 120 and 130 and “nighttime” may be added to records for images 140 and 150. In another embodiment of the present invention, the attribute may be inserted directly into the file, perhaps adding it to an auxiliary data field such as that which is present in the JPEG standard for storing auxiliary information such as date taken, resolution, etc.

Continuing with FIG. 1, looking at images 120 and 140 it can be determined that the woman 100 and 104 appear in both images. In another embodiment, facial recognition may be used to determine if woman 100 and woman 104 are indeed the same person. In an embodiment of the present invention, the first time woman 100 is detected; the user may be prompted to identify this person, perhaps by name (Jane) or by other attributes such as gender, organization, etc. In one embodiment of the present invention relating to a collection of images of a particular business, the attribute may be name and department so that images containing certain individuals may be located or all images of individuals within a certain organization may be located. Once attributes are entered for this person, upon subsequent exposure to the same individual, the recognition software would determine that, perhaps woman 104 is the same person as woman 100, and copy the attributes associated with woman 100 (for example: name is Jane) into the attributes for image 140. Looking now at images 130 and 150 it can be determined that man 102 and man 108 appear in both images. Facial recognition may again be used to determine if man 102 and man 108 are likely to be the same person. In an embodiment of the present invention, the first time man 102 is detected; the user may be prompted to identify this person, perhaps by name (John) or by other attributes such as gender, organization, etc. In one embodiment of the present invention relating to a collection of images of a particular business, the attribute may be name and department so that images containing certain individuals may be located or all images of individuals within a certain organization may be located. Once attributes are entered for this person, upon subsequent exposure to the same individual, the recognition software would determine that, perhaps man 108 is likely to be the same person as man 102, and copy the attributes associated with man 102 into the attribute information for image 150. In another embodiment, the recognition software may not be 100% certain that man 108 is the same as man 102 and may request verification from the user. If verified, the attributes associated with man 102 would be copied into the information for image 150. If not verified, the user may be prompted to enter information for the unidentified man 108, which would then be stored with the information for the image 150.

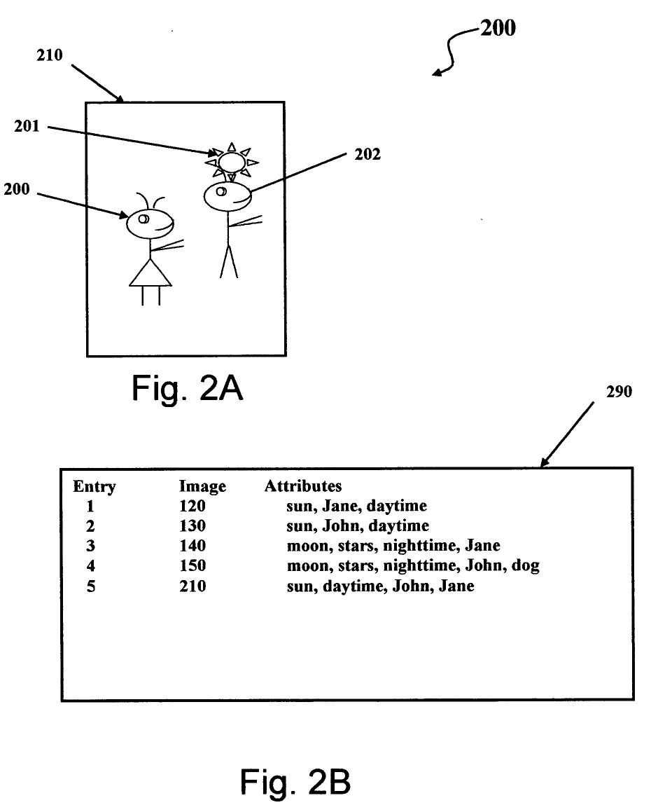

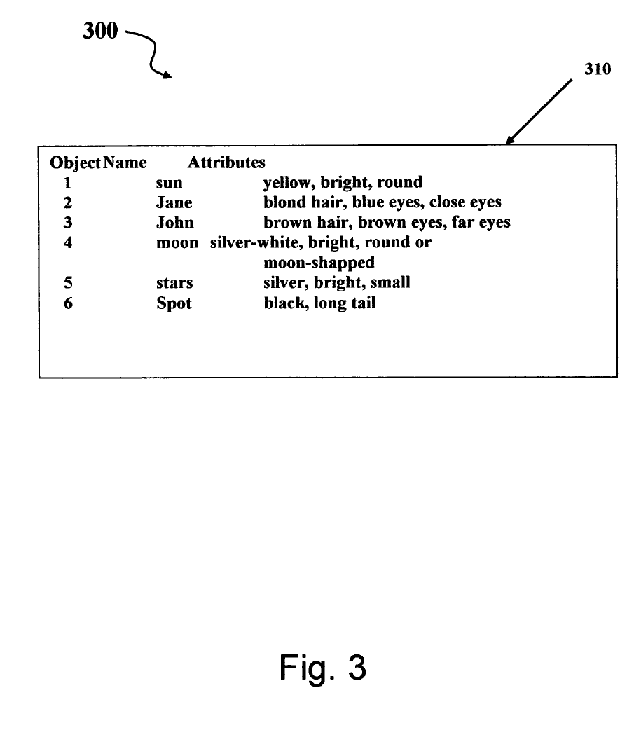

Referring now to FIG. 2, an additional image 210 with objects Jane 200, John 202 and the sun 201 is presented. If the system of the present invention has already analyzed the four images shown in FIG. 1, it may have created an image database 290 with entries 1-4 and an object collection 310 (FIG. 3). Entry 1 identifies the objects found in the image 120, entry 2 the objects in the image 130, entry 3 the objects in the object 140 and entry 4 the objects in the image 150. Referring to the object collection 310, each object known to the system is categorized by its attributes. The attributes in this table are shown for example but more complex attributes may be stored for each object. In this example, attributes such as object color, hair color, eye color and the like are shown. In other embodiments, this table may contain very detailed information that may be used to recognize the same or similar objects as they are detected by the system. In this example, Jane is characterized by hair_color=blond, eye_color=blue, and close-eyes. With a simple characterization such as this, all objects that resemble Jane would be categorized as Jane, in that if they had blond hair, blue eyes and its eyes were relatively close to each other. In another embodiment, facial recognition data could be stored, similar to that which is used by security systems to recognize people. This may include scar information, dimple information, eyebrow details, hair length, hair style, eye size, eye color, ear size, ear location, eye location, lip color, eye/ear/nose/mouth relationships, nose shape, nose size, chin size, etc. The same algorithms used to recognize faces may be used to recognize objects in this invention, although being that there may be a limit number of objects in a particular image library, the accuracy of the recognition algorithm does not need to be as high as that used in security applications. Furthermore, the recognition algorithm may need to recognize an object that is partially obstructed or turned at various angles, whereas security applications usually have an image of an object that is facing forward and unobstructed. Again, accuracy is not critical, in that if the recognition algorithm can't identify a few objects, the user will be prompted to identify the object, requiring occasional user intervention.

Continuing with the introduction of the image 210 into the system, the recognition algorithm may identify a first object, perhaps object 200. It would then determine the attributes of this object, in this case blond hair, blue eyes and close eyes. Next, it would search the object collection 310 to see if it can locate another object with the same or similar attributes, finding that Object-2 has these attributes, it would add Object-2's name to a new entry in the image database 290 (Entry-5) corresponding to image 210. It would then detect a next object, perhaps object 201. It would then determine that this object is yellow, bright and round. Next, searching the object collection 310, it would find that Object-1 has attributes of yellow, bright and round and determine that this object is most likely the same as Object-1 and would add Object-1's name to the new entry in the image database 290 (Entry-5). If, perhaps, the sun was setting and was orange instead of yellow, the algorithm would search table for an object that is orange, bright and round. Not finding an exact match, it would determine that Object-1 is the closest, matching bright and round, but not orange. The algorithm could guess that this is the same object or it could prompt the user to confirm that it is the same object. If the user indicates that it is a different object, perhaps Mars, then a new entry would be created in the object collection 310, perhaps named Mars, with the attributes of round, bright and orange. If the user indicates that they are the same object, then the algorithm may update the object collection 310 entry for Object-1 to include the new attribute for the sun, possibly changing the attribute list for Object-1 to (yellow or orange), bright and round. Finally, the algorithm may find a third object 202, with brown hair, brown eyes and far eyes. Again, searching the object collection 310, it would be determined that this object is likely Object-3 and the name John would be added to Entry-5 of the image database 290.

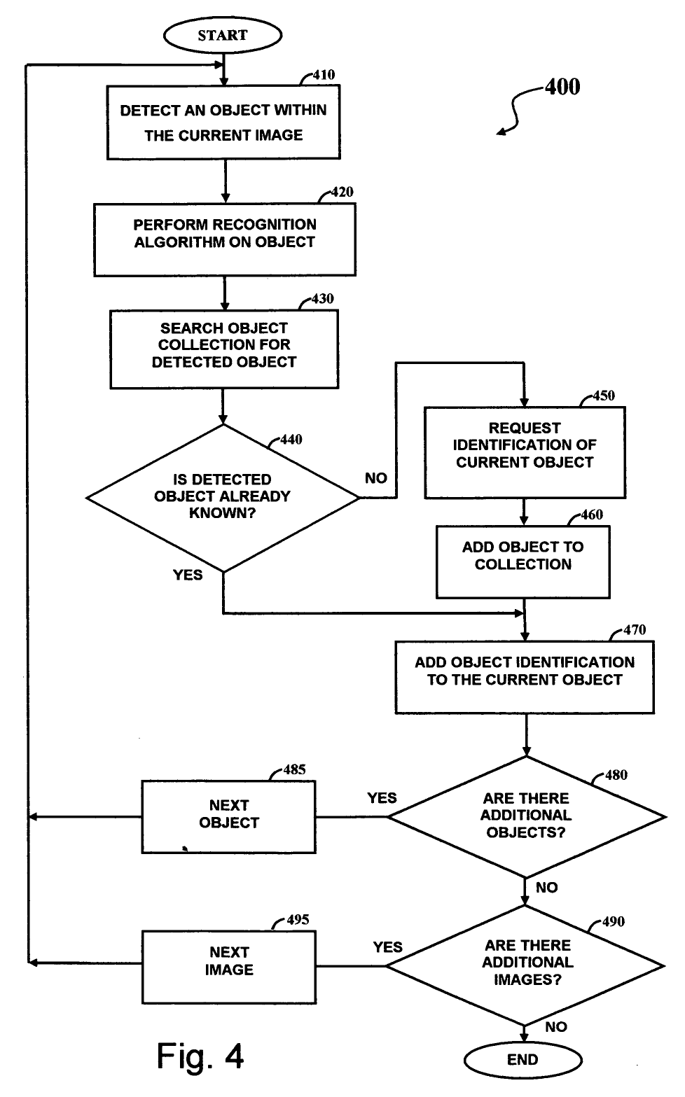

Referring now to FIG. 4, the classification steps of the present invention will be described. An object is detected within the current image at step 410. This detection may be performed by any algorithm known to the industry, for example, edge detection, contrast detection, shape detection, color detection and the like. Once detected, recognition algorithms are performed on the object (420). For example, the overall color or colors of the object may be detected, the shape of the object may be detected, for people, various color attributes, sizes and distance ratios may be detected or facial recognition may be performed, etc. Once recognition is complete, a search is performed 430 of an object collection or database looking for a known object that may already have been catalogued. The search may look for an exact match or, in another embodiment, look for a close match. Next, it is determined if a match or close match has been found 440. If not, a request for information about the object is made 450, since it is a new object to the system. The request may be for one or more identifying parameters; perhaps a name or other identifier. Once the information is received, the new object is added to the object collection or database 460. Continuing with the located object or the new object, the object description is added to the image 470. In one embodiment, the object key may be added to a record associated with the image. In another embodiment, the object's attributes may be added to the record associated with the image. In still another embodiment, the object key may be added to the image within the image's auxiliary data section. In another embodiment, the object's attributes may be added to the image within, perhaps, the image's auxiliary data section. Next, it is determined if there are additional objects in the image 480. If there are additional objects, the next object within the current image is selected (485) and steps 410 through 480 are performed on this object. If there are no additional objects, it is determined if there are additional images to process (490). If there are additional images, the next image to process is selected 495 and steps 410 through 490 are performed for this image, repeating until all objects within all images are processed. In another embodiment, all objects within a given image may be detected, looked up in the collection and added to the record associated with the image at one time, after all objects are processed.

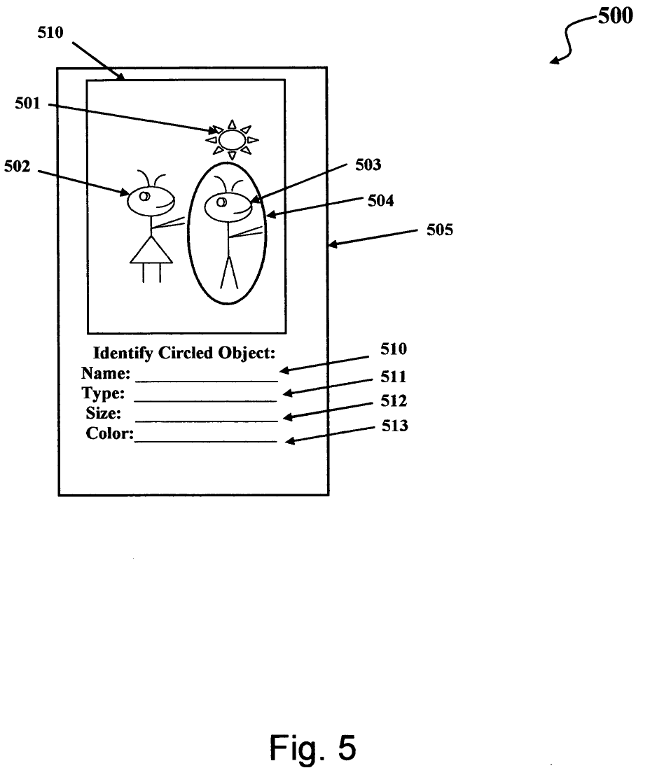

Referring now to FIG. 5, an example of a user interface of the present invention will be described. The image 510 that is currently being analyzed is displayed on a computer screen 505. The image currently displayed 510 contains three objects: a sun 501, a woman 502 and a man 503. During analysis of this image 510, the sun 501 may have already been identified by its shape, color and intensity as being the sun. Furthermore, the woman 502 may have been already identified through facial recognition as Jane after comparing the detected object with objects within the existing collection of objects. After searching for the man 503 in the existing collection, a similar object could not be found. Therefore, a circle 504 is drawn around the man 503 to indicate which object is unknown, then a set of prompts are displayed at the bottom portion of the computer screen 505, perhaps consisting of a prompt for: a name 510, a type 511, a size 512 and a color 513. For this object, perhaps type would be pre-filled in with “man” and only name would be pertinent. In some embodiments of the present invention, other prompts may appear depending on the type of object. For example, if the object is a dog then perhaps prompts for name, color and breed may be presented. In some embodiments, being that the recognition process may not be exact or the object may be partially obscured, a selection may be possible to identify the circled object as one that is already known. For example, if the object 503 was not a man, but was a woman and was known by the user as Jane, then the user may make a selection to make this object known as the same as object 502. In some embodiments, there may be selection points instead of data entry fields. For example, if a dog is recognized, a name prompt 510 may be displayed, but instead of additional prompts, perhaps a set of radio buttons may be displayed. For example, radio buttons for “German Shepard,” “Poodle,” “Doberman,” and “Collie” may be displayed.

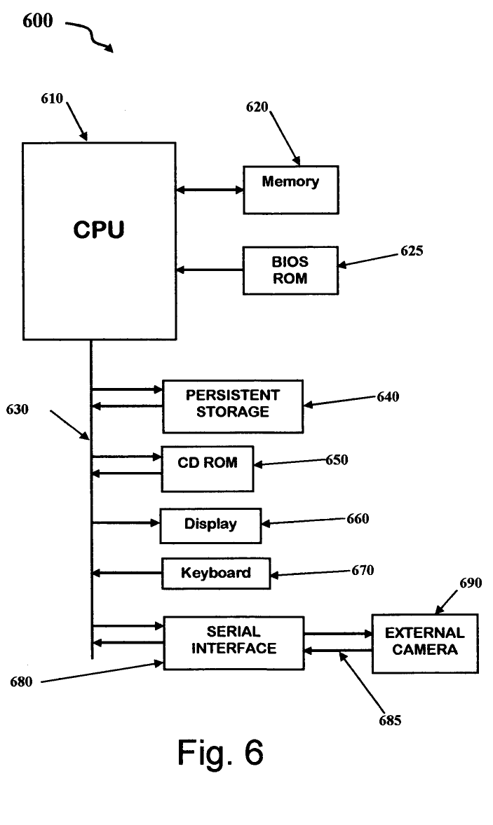

Referring to FIG. 6, a system block diagram of a computer system of the present invention. In this, a processor 610 is provided to execute stored programs that are generally stored within a memory 620. The processor 610 can be any processor, perhaps an Intel Pentium-4® CPU or the like. The memory 120, connected to the processor 610, can be any memory suitable for connection with the selected processor 110, such as SRAM, DRAM, SDRAM, RDRAM, DDR, DDR-2, etc. The BIOS ROM 625 is possibly a read-only memory that is connected to the processor 610 and may contain initialization software, sometimes known as BIOS. This initialization software usually operates when power is applied to the system or when the system is reset. Sometimes, the software is read and executed directly from the BIOS ROM 625. Alternately, the initialization software may be copied into the memory 620 and executed from there to improve performance. Also connected to the processor 610 is a bus 630 for connecting peripheral subsystems such as a persistent memory 640, a CDROM 650, a display 660, a keyboard 670 and a serial interface 680. In general, the persistent memory 640 may be used to store programs, executable code and data such that they remain intact even when power is turned off or disconnected. Examples of the persistent memory 640 are hard disks, flash, FRAM, memory cards, etc. In the present invention, the persistent memory 640 may be used to store the application of the present invention, images, object collections and databases for locating images. The removable media storage 650 may be used to load said programs, executable code and images from removable media onto the persistent memory 640. The serial interface 680 allows images to be copied from a camera 690 onto the persistent storage 640 through a cable 685. Examples of the serial interface 680 are serial ports (e.g., RS-232), universal serial bus (USB) and IEEE 1394 (Firewire). Examples of removable media storage includes CD, CDRW, DVD, DVD writeable, compact flash, other removable flash media, floppy disk, ZIP®, laser disk, etc. Although FIG. 6 shows an exemplary computing system; the present invention is not limited to any particular computer system architecture.

Although the invention has been described with a certain degree of particularity, it should be recognized that elements thereof may be altered by persons skilled in the art without departing from the spirit and scope of the invention. It is believed that restricted prepaid calling card and method of setting restrictions of the present invention and many of its attendant advantages will be understood by the foregoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

1-19. (canceled)

20. A computer-based apparatus for categorizing digital images, the apparatus comprising:
a processor;
a storage device operatively coupled to the processor;
a digital image stored in a file within the storage device;
an object detector software module executed by the processor, the object detector software module configured to isolate at least one object within the digital image;
an object collection comprising at least one known object; and
an object recognition module executed by the processor, the object recognition module adapted to identify each of the at least one objects and the object recognition module adapted to locate the at least one object within the object collection, the object recognition module adapted to associate searchable criteria from the object collection with the digital image.

21. The apparatus for categorizing digital images according to claim 20, wherein the searchable criteria are stored in a database.

22. The apparatus for categorizing digital images according to claim 20, wherein the searchable criteria are stored in auxiliary information within the file.

23. The apparatus for categorizing digital images according to claim 20, wherein the object collection is a database.

24. The apparatus for categorizing digital images according to claim 23, wherein object attributes are added to the object collection through a user interface.

25. The apparatus for categorizing digital images according to claim 20, wherein the searchable criteria is one or more elements selected from the group consisting of scar information, dimple information, eyebrow information, hair length, hair style, eye size, eye color, ear size, ear location, lip color, eye/ear/nose/mouth relationships, nose shape, nose size and chin size.

26. The apparatus for categorizing digital images according to claim 20, further comprising a user interface module executed by the processor, the user interface module adapted to provide notice upon detection of an object that cannot be found in the object collection by the object recognition module, the user interface adapted to accept information about the object that cannot be found and adding the information to the object collection.

27. A method for identifying objects within a digital image, the digital image stored in a file, the method comprising the steps of:
detecting all objects within the digital image;
for each object detected:
searching an object database for the detected object;
if the detected object is found, relating stored attributes associated with the detected object to the file; and
if the detected object is not found, obtaining attributes related to the detected object; adding the attributes related to the detected object to the object database and relating the attributes related to the detected object to the object file.

28. The method of claim 27, wherein the attributes is at least one elements selected from the group consisting of scar information, dimple information, eyebrow information, hair length, hair style, eye size, eye color, ear size, ear location, lip color, eye/ear/nose/mouth relationships, nose shape, nose size and chin size.

29. The method of claim 27, wherein said relating includes storing the attributes in the file containing the digital image.

30. The method of claim 29, further comprising the step of:
obtaining at least one search attribute;
searching the file for the at least one search attribute; and
identifying all digital images that match the at least one search attribute.

31. The method of claim 27, wherein said relating includes storing the attributes in an image database.

32. The method of claim 31, further comprising the step of:
obtaining at least one search attribute;
searching the image database for the at least one search attribute; and
identifying all digital images that match the at least one search attribute.

33. A computer program product for identifying objects within a digital image the digital image stored in a computer readable file comprising a computer readable storage medium having a computer program stored thereon for performing the steps of:
detecting objects within the digital image;
for each object detected:
searching an object database for the detected object;
if the detected object is found, relating stored attributes associated with the detected object to the file; and
if the detected object is not found, obtaining attributes related to the detected object; adding the attributes related to the detected object to the object database and relating the attributes related to the detected object to the object file.

34. The computer program product of claim 33, wherein the attributes is at least one elements selected from the group consisting of scar information, dimple information, eyebrow information, hair length, hair style, eye size, eye color, ear size, ear location, lip color, eye/ear/nose/mouth relationships, nose shape, nose size and chin size.

35. The computer program product of claim 33, wherein said relating includes storing the attributes in the file containing the digital image.

36. The computer program product of claim 35, further comprising the step of:
obtaining at least one search attribute;
searching the file for the at least one search attribute; and
identifying all digital images that match the at least one search attribute.

37. The computer program product of claim 33, wherein said relating includes storing the attributes in an image database.

38. The computer program product of claim 37, further comprising the step of:
obtaining at least one search attribute;
searching the image database for the at least one search attribute; and
identifying all digital images that match the at least one search attribute.
